(19) United States
(12) Patent Application Publication
(10) Pub. No.: US 2007/0040841 A1
(43) Pub. Date: Feb. 22, 2007

(54) Display apparatus and control method thereof

(75) Inventor: Young-chan Kim, Uiwang-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/503,207

(22) Filed: Aug. 14, 2006

(30) Foreign Application Priority Data
Aug. 22, 2005 (KR) 2005-76714

(51) Int. Cl. G09G 5/39

(52) U.S. Cl. 345/531

(57) ABSTRACT

A display apparatus includes a display unit to display an image, an image processing unit to apply an image signal to the display unit, a nonvolatile memory having a data area to adjust a display state of the image displayed on the display unit, a correction data area to store predetermined correction data, and a program code area to store program codes, and a micro control unit to control the image based on the program codes and to change the correction data such that a data checksum value of the data area and the correction data area is conserved as a predetermined reference data checksum value when data stored in the data area are changed.

### CROSS-REFERENCE TO RELATED APPLICATIONS

This application claims the benefit of Korean Patent Application No. 2005-0076714, filed on Aug. 22, 2005, in the Korean Intellectual Property Office, the disclosure of which is incorporated herein in its entirety by reference.

### BACKGROUND OF THE INVENTION

1. Field of the Invention

The present general inventive concept relates to a display apparatus and a control method thereof, and more particularly, to a display apparatus, which is capable of conserving a checksum value of entire data of a nonvolatile memory provided in a micro control unit even when color data stored in a color data area of the nonvolatile memory are changed, and a control method thereof.

2. Description of the Related Art

In general, a display apparatus processes an image signal, which may have a predetermined color mode, for example, a gray mode, an RGB mode or a CYMK mode, transmitted from a signal source, for example, an information processing apparatus such as a computer, in order to provide a visible image to a user. The display apparatus adjusts a gain value for each color of the image signal through a predetermined signal process, so that images having a variety of colors are displayed on a display unit of the display apparatus.

With the increase of demand for high-definition display apparatuses, there have been a variety of needs to adjust colors of images displayed in the display apparatus in order to obtain optimal moving pictures for multimedia, and accordingly, massive color data have been required.

In addition, there is an increasing need to handle colors of images displayed in the display apparatus in order to match colors of an image displayed in the display apparatus with colors of an image printed on a paper.

Color data of the images displayed on a display unit of the display apparatus may be detected by a separate detector. If a great quantity of color data has to be updated to adjust the colors of the image displayed in the display apparatus based on the color data detected by the detector, a separate memory, such as an EEPROM, to store the color data has to be provided in the display apparatus.

In addition, an updating speed of the color data is increased by allocating the color data in a specified area of a RAM built in a micro control unit for driving various parts of the display apparatus and collectively loading and updating the color data from the separate memory. At this time, the update operation may be performed using a separate RAM other than the built-in RAM of the micro control unit.

Referring to FIG. 1, a conventional display apparatus includes nonvolatile memories such as flash ROMs 100a and 100b in a micro control unit. The flash ROMs 100a and 100b are divided into a program code area in which program codes for driving of the display apparatus are stored and a data area in which data other than the program codes are stored.

During manufacturing of the display apparatus or in the course of after-service after shipping of the display apparatus, it is checked whether or not the program codes stored in the program code area are lost or corrupted through a data checksum value of the flash ROMs 100a and 100b.

In such a conventional display apparatus, however, the use of EEPROMs, which are separated from the micro control unit, to store the color data results in decrease of an update operation speed as well as increase of costs.

In addition, when a built-in RAM of the micro control unit (or separate RAM) is used in the display apparatus, the RAM is divided into a general-purpose RAM area 110a for normal data processing and a color data area 110b, which may result in an insufficient space for other required processes.

Accordingly, since the flash ROMs 100a and 100b in the micro control unit is not used to store the color data, an execution speed of color adjustment has been decreased.

In addition, the color data is not stored in the flash ROMs 100a and 100b, a checksum value of entire data of the flash ROMs 100a and 100b is not conserved when the color data are changed, and the checksum value of entire data of the flash ROMs 100a and 100b is not changed dependent on only loss or corruption of the program codes stored in the flash ROMs 100a and 100b.

### SUMMARY OF THE INVENTION

The present general inventive concept provides a simplified display apparatus having no separate external memory, which is capable of increasing an execution speed of color adjustment by allocating a color data area in a nonvolatile memory provided in a micro control unit, and a control method thereof.

The present general inventive concept provides a display apparatus, which is capable of conserving a checksum value of entire data of a nonvolatile memory provided in a micro control unit even when color data stored in a color data area of the nonvolatile memory are changed, and a control method thereof.

Additional aspects and advantages of the present general inventive concept will be set forth in part in the description which follows and, in part, will be obvious from the description, or may be learned by practice of the general inventive concept

The forgoing and/or other aspects and advantages of the present general inventive concept may be achieved by providing a display apparatus comprising a display unit to display an image and an image processing unit to apply an image signal to the display unit, the display apparatus comprising a nonvolatile memory having a data area to store data to adjust a display state of the image displayed on the display unit, a correction data area to store predetermined correction data, and a program code area to store program codes, and a micro control unit to control the displayed image based on the program codes and to change the correction data such that a data checksum value of the data area and the correction data area is conserved as a predetermined reference data checksum value when the data stored in the data area are changed.

The nonvolatile memory may comprise a flash ROM.

The flash ROM may be provided in the micro control unit.

The reference data checksum value may be set as a data checksum value for the data and the correction data first stored in the data area and the correction data area, respectively.

The micro control unit may change the data stored in the data area based on data provided from an external information processing apparatus that applies an image signal to the display apparatus.

The data stored in the data area are color data to adjust the display state of the image displayed on the display unit.

The foregoing and/or other aspects and advantages of the present general inventive concept may also be achieved by providing a method of controlling a display apparatus comprising a display unit to display an image, a color adjusting unit to apply an image signal to the display unit, and a nonvolatile memory comprising a data area to adjust a display state of the image displayed on the display unit, a correction data area to store predetermined correction data, and a program code area to store program codes, the method comprising setting a predetermined reference data checksum value, changing data stored in the data area, and changing the correction data of the correction data area such that a data checksum value of the changed data area and the correction data area is conserved as the reference data checksum value.

The nonvolatile memory may comprise a flash ROM.

The flash ROM may be provided in a micro control unit.

The reference data checksum value may be set as a data checksum value for the data and the correction data first stored in the data area and the correction data area, respectively.

The data stored in the data area may be color data to adjust the display state of the image displayed on the display unit.

The foregoing and/or other aspects and advantages of the present general inventive concept may also be achieved by providing a display apparatus comprising a display unit to display an image and a color adjusting unit to apply an image signal to the display unit, the display apparatus comprising an interface to receive an image signal and a control signal, a micro control unit formed with a nonvolatile memory in a single monolithic body, having a data area to store data to adjust a display state of the image displayed on the display unit according to the image signal, a correction data area to store predetermined correction data according to the data and the control signal, and a program code area to store program codes to operate the micro control unit.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating internal area allocation of flash ROMs and a RAM provided in a conventional display apparatus;

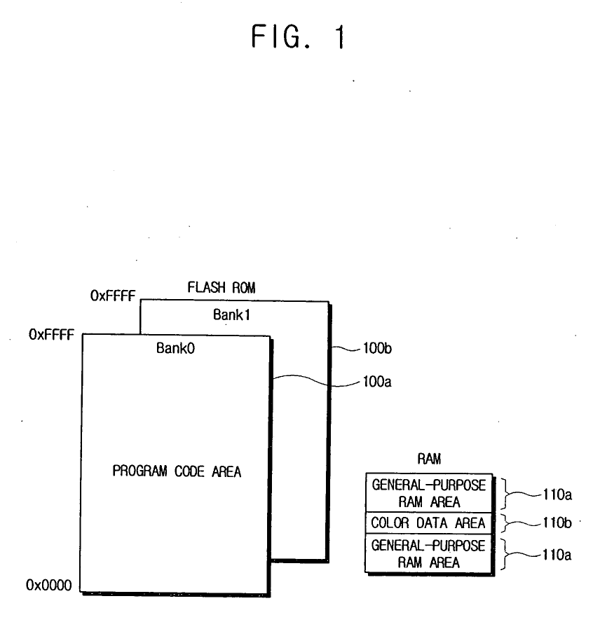

FIG. 2 is a block diagram illustrating a display apparatus according to an embodiment of the present general inventive concept;

FIG. 3 is a view illustrating internal area allocation of flash ROMs provided in the display apparatus according to the embodiment of the present general inventive concept;

FIG. 4 is a flow chart illustrating a control method of a display apparatus according to the embodiment of the present general inventive concept; and

FIG. 5 is a view illustrating a data checksum value of the flash ROMs provided in the display apparatus of FIG. 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

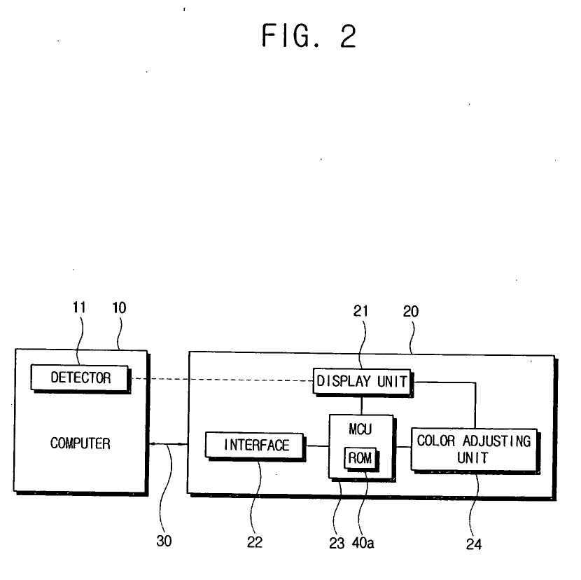

FIG. 2 is a block diagram illustrating a display apparatus 20 according to an embodiment of the present general inventive concept. Referring to FIG. 2, the display apparatus 20 includes an interface 22 to receive color data from an external information processing apparatus, a display unit 21 to display an image based on the color data provided through the interface 22, a color adjusting unit 24 to adjust color of the image displayed on the display unit 21, and a micro control unit (MCU) 23 to control components thereof.

The micro control unit 23 contains a nonvolatile memory to store a variety of data required for operation of the display apparatus 20. The nonvolatile memory of the present embodiment is one or more flash ROMs 40a and 40b, for example, which will be described below.

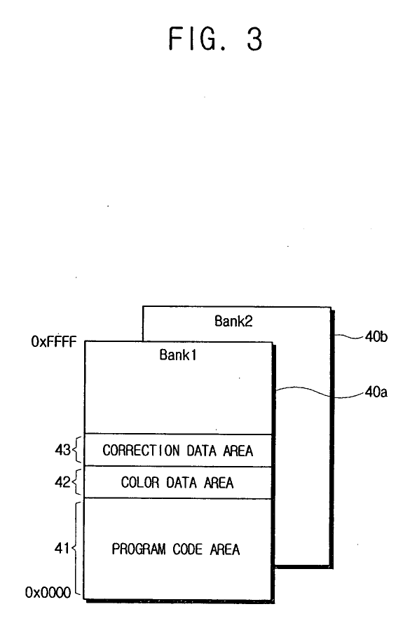

As illustrated in FIGS. 2 and 3, the flash ROMs 40a and 40b of the present embodiment includes a color data area 42 in which color data used to adjust a display state of an image displayed on the display unit 21 are stored, a correction data area 43 in which predetermined correction data are stored, and a program code area 41 in which program codes are stored. Here, the color adjusting unit 24 adjusts the display state of a color and the like of the image displayed on the display unit 21 based on the color data stored in the color data area 42 of the flash ROMs 40a and 40b. The color data area 42 and the stored color data are only examples of data areas and data stored therein in the present embodiment.

An array of color data in accordance with a color adjustment file generated in the external information processing apparatus, for example, a computer 10, is stored in the color data area 42 of the flash ROMs 40a and 40b based on a predetermined control signal. At this time, the control signal is provided from the computer 10 to the display apparatus based on ISP (In_System Programming) instructions. In the embodiment of the present embodiment, an operation of storing required color data in the flash ROMs 40a and 40b built in the micro control unit 23 or reading and erasing the color data stored in the flash ROMs 40a and 40b is performed based on the ISP instructions. The color adjustment file in this embodiment is an example of data provided from the external information processing apparatus in the present invention.

The computer 10 operates as a control apparatus for color adjustment by providing the color data in accordance with the color adjustment file and is connected to the interface 22 of the display apparatus 20 via a predetermined signal line 30. Here, the signal line 30 and the interface 22 may be provided in a manner adapted to various transmission systems, such as a USB system, serial port system, or a DDC (Display Data Channel) system. Accordingly, the color data provided from the computer 10 to terminal pins (not shown) provided in the interface 22 may be transmitted to and stored in the flash ROMs 40a and 40b.

Here, the computer 10 may further include a detector 11 to detect an image pattern of the image displayed on the display unit 21. Although it is illustrated in this embodiment that the detector 11 is included in the computer 10, it may be provided separately from the computer 10. Alternatively, the detector 11 may be provided in a predetermined region in the display apparatus 20 and may be configured to provide detected color data (or detected image pattern) of the displayed image to the information processing apparatus via a separate signal line (not shown).

The detector 11 provides the computer 10 with a detection signal for the color data of the image displayed on the display unit 21. Based on this detection signal, the computer 10 performs a color adjusting process and then may determine whether or not an adjustment value is equal to a gain value set for each color. Based on a result of the determination, when color of the image displayed on the display unit 21 is adjusted based on the detection signal from the detector 11, the array of color data in accordance with the color adjustment file is provided to the display apparatus 20, as described above.

In addition, the computer 10 prepares a reference color adjustment file for the array of color data corresponding to a predetermined reference color pattern, and the array of color data of the reference color adjustment file can be stored in the color data area 42 of the flash ROMs 40a and 40b built in the micro control unit 23 of the display apparatus 20.

Here, a reference color pattern may be prepared as various color profiles based on predetermined color coordinate values and may be set as a gray mode, RGB mode or CYMK mode. In addition, the reference color pattern may be set as a skin color mode, a grass color mode, or a sky color mode based on skin color, grass color or sky color.

In the mean time, the micro control unit 23 controls an image signal processing part, i.e., the color adjusting unit 24 and/or the display unit 21, based on the program codes stored in the flash ROMs 40a and 40b.

In addition, when the color data stored in the color data area 42 of the flash ROMs 40a and 40b are changed by the above-described method, the micro control unit 23 changes the correction data such that a data checksum value of the color data area 42 and the correction data area 43 is conserved as a predetermined reference data checksum value. Here, the reference data checksum value may be set as the data checksum value for the color data and the correction data first stored in the color data area 42 and the correction data area 43, respectively. Alternatively, the reference data checksum value may be set as a fixed value.

Accordingly, as the data checksum value of the color data area 42 and the correction data area 43 is conserved as a checksum value of the first stored color data and correction data, the checksum value of entire data of the flash ROMs 40a and 40b is changed only when the program codes stored in the program code area 41 are changed. Accordingly, when the checksum value of entire data of the flash ROMs 40a and 40b is checked, a version of the program code area 41 or data errors may be confirmed according to the checksum value. That is, the confirmed version of the changed program codes of the program code area 41 can be used to operate the micro control unit 23 to control the display unit 21 and the color adjusting unit 24 to adjust the color data of the image according to the checksum value. The changed program codes of the program code area 41 can be used together with the data of the data area 42 and the correction data of the correction data area 43 to control the color data of the image to be displayed according to the checksum value. The checksum value may be stored in the flash ROMS 40a and/or 40b, i.e., the data area 42 or the data correction area 43.

Hereinafter, an exemplary process in which the micro control unit 23 changes the correction data of the correction data area 43 depending on the change of the color data stored in the color data area 42 will be described in detail. In the following description, it is exemplified that only two lower bytes of the entire bytes are taken and used as a checksum value.

Assuming that the data checksum value of the color data first stored in the color data area 42 of the flash ROMs 40a and 40b is 0×0407 and the reference data checksum value is 0×10000, the micro control unit 23 changes the correction data of the correction data area 43 such that the data checksum value of the color data area 42 and the correction data area 43 is conserved as 0×10000.

First, the data checksum value of the correction data area 43 can be 0×FBF9 (=0×10000−0×0407), and accordingly, the micro control unit 23 stores the correction data of a 0×FBF9 size in the correction data area 43.

Here, it is assumed that the micro control unit 23 uses a quotient of 0×FC and a remainder of 0×F5 when 0×FBF9 is divided by 0×FF as a method of storing the correction data of a 0×FBF9 size. That is, the micro control unit 23 stores 0×FC correction data each correction data having a 0×FF size and one correction data having a 0×F5 size in a portion of the correction data area 43, and stores remaining correction data having a 0×00 size in a remaining portion of the correction data area 43.

Then, when the color data of the flash ROMs 40a and 40b are changed, as described above, for example when the data checksum value of the changed color data is changed to 0×0405, the micro control unit 23 stores the correction data of a 0×FBFB in the correction data area 43.

Here, the micro control unit 23 stores the 0×FC correction data each having the 0×FF size and one correction data of the 0×F7 size in the portion of the correction data area 43, and stores the remaining correction data having the 0×00 size in the remaining portion of the correction data area 43.

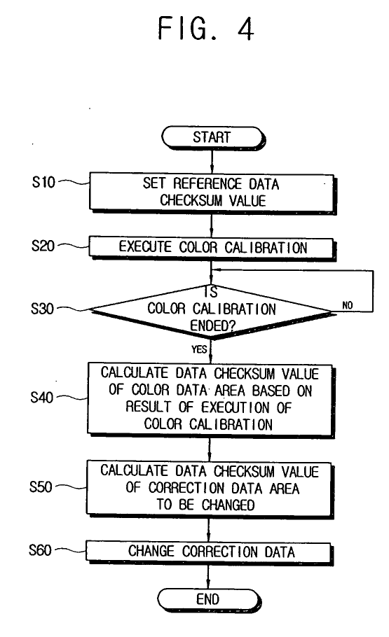

FIG. 4 is a view illustrating a control process of the display apparatus 20 according to the embodiment of the present general inventive concept. In the following description, it is assumed that the color data stored in the color data area 42 are color calibration adjustment data.

Referring to FIGS. 2 through 4, at operation S10, a reference data checksum value is set as described above. At operation S20, color calibration is executed in the computer 10. When it is determined at operation S30 that the color calibration is ended, the computer 10 transmits color data produced as an execution result of the color calibration to the display apparatus 20, and the micro control unit 23 of the display apparatus 20 stores the color data transmitted from the computer 10 in the color data area 42 of the flash ROMs 40a and 40b.

Then, at operation S40, the micro control unit 23 calculates a data checksum value of the color data produced as the execution result of the color calibration, that is, the color data newly stored in the color data area 42.

Then, at operation S50, a data checksum value of the correction data area 43 to be changed is calculated based on the reference data checksum value and the calculated data checksum value of the color data. Then, at operation S60, correction data are changed according to the above-described method.

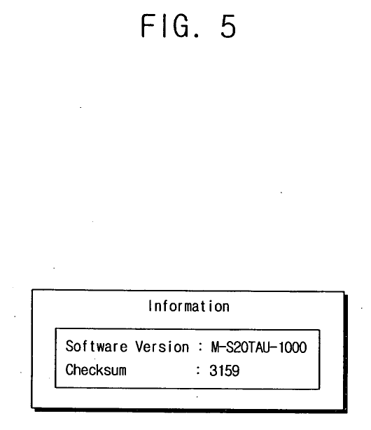

Accordingly, when the checksum value of the entire data of the flash ROMs 40a and 40b is indicated as shown in FIG. 5, the checksum value of the entire data is not changed even when the color data of the color data area 42 is changed according to the changed data checksum value.

As apparent from the description, the present general inventive concept provides a simplified display apparatus having no separate external memory, which is capable of increasing an execution speed of color adjustment by allocating a color data area in a nonvolatile memory provided in a micro control unit, and a control method thereof.

In addition, the present general inventive concept provides a display apparatus, which is capable of conserving a checksum value of entire data of a nonvolatile memory provided in a micro control unit even when color data stored in a color data area of the nonvolatile memory are changed, and a control method thereof.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus comprising a display unit to display an image and an image processing unit to apply an image signal to the display unit, comprising:
a nonvolatile memory comprising a data area to adjust a display state of the image displayed on the display unit, a correction data area to store predetermined correction data, and a program code area to store program codes; and
a micro control unit to control the image to be displayed based on the program codes and to change the correction data such that a data checksum value of the data area and the correction data area is conserved as a predetermined reference data checksum value when data stored in the data area are changed.

2. The apparatus according to claim 1, wherein the nonvolatile memory comprises a flash ROM.

3. The apparatus according to claim 2, wherein the flash ROM is provided in the micro control unit.

4. The apparatus according to claim 3, wherein the reference data checksum value is set as a data checksum value for the data and the correction data first stored in the data area and the correction data area, respectively.

5. The apparatus according to claim 3, wherein the micro control unit changes the data stored in the data area based on data provided from an external information processing apparatus that applies an image signal to the display apparatus.

6. The apparatus according to claim 1, wherein the data stored in the data area are color data to adjust the display state of the image displayed on the display unit.

7. The apparatus according to claim 1, wherein the micro control unit and the nonvolatile memory are formed in a single monolithic body.

8. A method of controlling a display apparatus comprising a display unit to display an image, a color adjusting unit to apply an image signal to the display unit, and a nonvolatile memory comprising a data area to adjust a display state of the image displayed on the display unit, a correction data area to store predetermined correction data, and a program code area to store program codes, the method comprising:
setting a predetermined reference data checksum value;
changing data stored in the data area; and
changing the correction data of the correction data area such that a data checksum value of the changed data area and the correction data area is conserved as the reference data checksum value.

9. The method according to claim 8, wherein the nonvolatile memory comprises a flash ROM.

10. The method according to claim 9, wherein the flash ROM is provided in a micro control unit.

11. The method according to claim 10, wherein the reference data checksum value is set as a data checksum value for the data and the correction data first stored in the data area and the correction data area, respectively.

12. The method according to claim 8, wherein the data stored in the data area are color data to adjust the display state of the image displayed on the display unit.

13. The method according to claim 8, further comprising:
controlling a micro control unit to set a predetermined reference data checksum value, change data stored in the data area, and change the correction data of the correction data area such that a data checksum value of the changed data area and the correction data area is conserved as the reference data checksum value,
wherein the nonvolatile memory is included in the micro control unit.

14. The method according to claim 13, wherein the micro control unit and the nonvolatile memory are formed in a single monolithic body.

15. A display apparatus comprising a display unit to display an image and a color adjusting unit to apply an image signal to the display unit, the display apparatus comprising:
an interface to receive an image signal and a control signal;
a micro control unit formed with a nonvolatile memory in a single monolithic body, having a data area to store data to adjust a display state of the image displayed on the display unit according to the image signal, a correction data area to store predetermined correction data according to the data and the control signal, and a program code area to store program codes to operate the micro control unit.

16. The display apparatus of claim 15, wherein the micro control unit controls the display unit and the color adjusting unit to adjust an image to be displayed on the display unit according to the data of the data area and the correction data of the correction data area.

17. The display apparatus of claim 15, wherein the micro control unit generates a data checksum value when the correction data is changed according to the control signal.
